(19) United States
(12) Patent Application Publication
(10) Pub. No.: US 2002/0004824 A1
(43) Pub. Date: Jan. 10, 2002

(54) Method and apparatus for automatically deploying data and simultaneously Executing computer program scripts in a computer network

(76) Inventors: William G. Cuan, Sunnyvale, CA (US); Kevin Cochrane, San Francisco, CA (US)

Correspondence Address: David R. Stevens, Stevens & Westberg LLP, 99 North First Street, Suite 201, San Jose, CA, 95113, US

(21) Appl. No.: 09/860,893

(22) Filed: May 17, 2001

Related U.S. Application Data
(60) Provisional application No. 60/205,805, filed on May 17, 2000.

(51) Int. Cl. G06F 15/16

(52) U.S. Cl. 709/208; 709/220; 709/229

(57) ABSTRACT

A method and apparatus is provided for deploying data using a website development software application and executing scripts related to such deployment. A system that utilizes the invention may work in synchronicity with the application to deploy theses scripts so that they can be executed in order to improve the delivery and maintenance of web content and related data. The scripts may be deployed using the same means as the deployed data, or may preexist within devices along the deployment path. Unlike other solutions, the unique use of scripts in such an application allows for further control and monitoring of locations along the deployment path, such as website production servers and other possibly disparate devices and systems. Another aspect provides security to deployment destinations by, requiring screening of incoming data deployments.

### RELATED APPLICATIONS

This application claims the benefit of U.S. Provisional Application No. 60/205,805, filed May 17, 2000; which is hereby incorporated by reference.

### BACKGROUND

The invention relates generally to the deployment of data in computer networks and, more particularly, relates to a method and apparatus for automatically deploying data to a plurality of locations and executing scripts in conjunction with such deployment.

Applications specifically tailored to developing and maintaining Internet websites are well known in the website development industry. Many of these applications offer simplified methods for designing and maintaining a website. These methods may include facilitating the receiving, storing and arranging of and the delivering of web content and related information in a website. In more advanced systems, information must be stored in multiple locations and in different files so that other advanced functions of the application program and related systems can operate and have access to certain information. Data deployment in such systems becomes more difficult as these applications become more complex.

Deployment of web content and related information can take on many forms. Deployments can occur internally in the development systems. One example of an internal deployment is the deployment of in-progress changes occurring in work areas to memory locations in the development server. Another example of an internal deployment is the transfer of content from a work area to other internal areas such as staging, editing and publishing areas. Deployments may also occur externally to the development system, such as the transfer of content and related information to outside devices or entities such as web production servers.

Due to the need to coordinate the efforts of many contributors, it is a challenge to develop large websites. Furthermore, many websites need to be frequently modified, which is usually done by numerous contributors that typically modify them in an ad hoc process. Problems occur when users from separate workstations try to update the same information on a website, confusing the process. Propounding the problem, many businesses require that their Internet sites be updated by the day, hour or minute, and by numerous contributors. And, as the number of contributors increases, so does the volume, and complexity of content, as well as its use. As information is created, it must be saved by all of these contributors, who may or may not be diligent in maintaining proper data preservation procedures. In some applications, the information must also be deployed to sometimes remote production servers where websites are hosted. As a result, managing the website for efficiency and quality control has become difficult.

In response to these problems, system applications have been developed for managing website development. Some of these include software configuration management systems, document management systems and database publishing systems. In one such application, websites may be developed within work areas where individual website developers construct or maintain separate portions of content that define a website. This helps to spread out the tasks of website development to multiple people. The final contributions from each developer may then be incorporated, and then deployed to a production server that hosts the final website.

There are several disadvantages associated with conventional website development systems. For example, where maintaining a website may require the efforts of large numbers of people, it may be desirable to have website contributors work in parallel. Software configuration management systems do not allow contributors to simultaneously make changes to the same area of a website. And, conventional systems typically do not allow individual contributors to separately test their own work without publishing to the website. The result is that individual contributors cannot foresee the effects of their contributions when combined with other contributions. Also, deployment of the website content is often done with little control over the deployment process itself. As a result, conflicting changes may be posted to a website, corrupting its content and undermining the website's integrity.

Conventional systems also sometimes rely on a central website control person known as a “webmaster” to integrate all changes posted to a website. This webmaster is solely responsible for the quality control of the website and for integrating all of the content. With the existence of multiple content contributors, the webmaster often becomes a bottleneck in maintaining and developing websites. Integrating the work of multiple contributors is a time consuming and labor intensive task, and includes debugging the content and resolving conflicts among contributors. To further complicate things, webmasters have no real-time control over the contribution process and even less control over the deployment for display on the final website. This makes it difficult if not impossible for the webmaster to properly organize and maintain a website. The webmaster is left to sort through errors, to resolve conflicts and to schedule website changes without any real control over the overall process.

Thus, in conventional systems, the deployment scenario from the content producer to the web server, if it exists at all, is typically predetermined and inflexible to change. Moreover, once the deployment of the data is initiated, there is no further control of the deployment of the content to the website production server. The conventional configuration may be characterized as a metaphoric equivalent to a black box, wherein content is sent and presumably loaded onto a website, without any further understanding or control of the process by the developers of the content, or any reassurance that the deployment has been successful.

Therefore, there exists a need in the website development industry for a method and apparatus configured to more efficiently deploy data in website development and maintenance applications. As will be seen below, the invention does this in an elegant manner.

### SUMMARY OF THE INVENTION

The invention is directed to a method and apparatus for deploying data using a website development software application and executing scripts related to such deployment. A system that utilizes the invention may work in synchronicity with the application to deploy theses scripts so that they can be executed in order to improve the delivery and maintenance of web content and related data. The scripts may be deployed using the same means as the deployed data, or may preexist within devices along the deployment path. Unlike other solutions, the unique use of scripts in such an application allows for further control and monitoring of locations along the deployment path, such as website production servers and other possibly disparate devices and systems. Another aspect provides security to deployment destinations by, requiring screening of incoming data deployments. These and other features of the invention will be apparent in detailed description below.

### BRIEF DESCRIPTION OF THE DRAWINGS

FIG. 1 illustrates a computer network system for website development in accordance with the present invention;

FIG. 2 illustrates a development system in accordance with the present invention;

FIG. 3 illustrates a development system in accordance with the present invention;

FIG. 4 illustrates a development system in accordance with the present invention;

FIG. 5 illustrate a development system in accordance with the present invention; and

FIG. 6 illustrate a development system in accordance with the present invention.

### DETAILED DESCRIPTION

The invention is directed to a method and apparatus for efficient deployment of data as well as the execution of commands related to such deployments. The invention may be used in a system for deploying data to disparate devices or systems that may be located in remote locations. The Internet is made up of a multitude of disparate systems exchanging disparate web content and other types of data and software programs, making up a very heterogeneous environment for exchanging web content and other data. Utilizing the invention, the deployment of such content can be composed to adapt to many disparate systems to distribute website content and related information. A system that utilizes the invention may work in synchronicity with the application to retrieve and deploy data that is created, modified or otherwise changed. One or more scripts may be executed over the course of deployment to exert certain controls on destination devices along the deployment path, improving the delivery and maintenance of web content and related data. In this context, the deployment path may be defined as the transmission of web content and related data via a series of machines between a source of the content and a destination. Such machines may be chained together or otherwise configured to enable the transmission of the content from the source to the destination or destinations, such as one or more production servers. These executable scripts may be pre-loaded in locations along the deployment path where they are used, or they may be deployed along with the data in which they are related. If the scripts are sent along with the data, they may be self-executing upon the occurrence of certain events. In a preferred embodiment, the scripts preexist in devices or entities along the deployment path before the deployment. Related execution commands may then be deployed out along with content to execute the preexisting scripts. They may also be sent by other means and executed according to the deployment configuration. The deployment and execution of the scripts may also be automatic in response to the occurrence of certain events, making the operations operate in the background of an application where they are transparent to the system operators.

In one embodiment of the invention, a computer system may be configured to execute software code that defines the relevant functions for performing web maintenance and development operations at disparate device and system locations according to the invention. A disparate device may be defined as a device that has different formats or operations than other systems with which it communicates, as a device in a geographical location that requires special processing in order to properly deploy the content, or as a device that needs additional processing in order to utilize certain web content or other information. In such systems, compatibility with other systems or devices may be an issue. One embodiment of the invention is directed to the ability to associating executable script commands with data and deploying them together to what may be disparate devices or systems. The scripts that these commands cause to be executed may be configured to perform operations related to the deployment of the data, or may be directed to perform other operations related to the development and maintenance of a website.

One embodiment of the invention may be characterized as a control apparatus for controlling web related activities or operations in devices and systems to locations where data may be deployed. Another embodiment of may be characterized as a messaging apparatus configured to broadcast the status or result to interested or concerned persons, machines or other entities. The invention is particularly adapted to deploying data and related script execution commands in an Internet website development software application and will be described in that context. It will be appreciated, however, that this is illustrative of only one utility of the invention, and that the invention has greater applicability and utility.

In a computer system that manages a quantity of data, the data is stored in computer memory in the form of files. For example, in a system for maintaining and making changes to content for a website, extranet site or intranet site, physical memory may be allocated for work areas, staging areas and edition areas. In one example of a web development and maintenance system, work areas may store in-progress changes to be made to the content by an individual contributor or group of contributors. Unlike conventional systems, this example may be configured to automatically retrieve, deploy and store content that culminates from these inprogress changes in a manner that may or may not be transparent to users maintaining and developing content. Once the changes are made in the work areas, the changed content may be submitted to a staging area or areas. In the staging area, the content changes may be combined. From the staging area, the changed content may be forwarded to an edition area or areas. The edition areas may store versions or editions of the content for the website, extranet site or intranet site. The data may then be deployed to devices or systems that may utilize such content. According to the invention, executable script commands may be deployed along with the data in order for operations or activities to be performed. These scripts allow for additional control over and monitoring of data destinations that may be remote and that may involve disparate devices or systems.

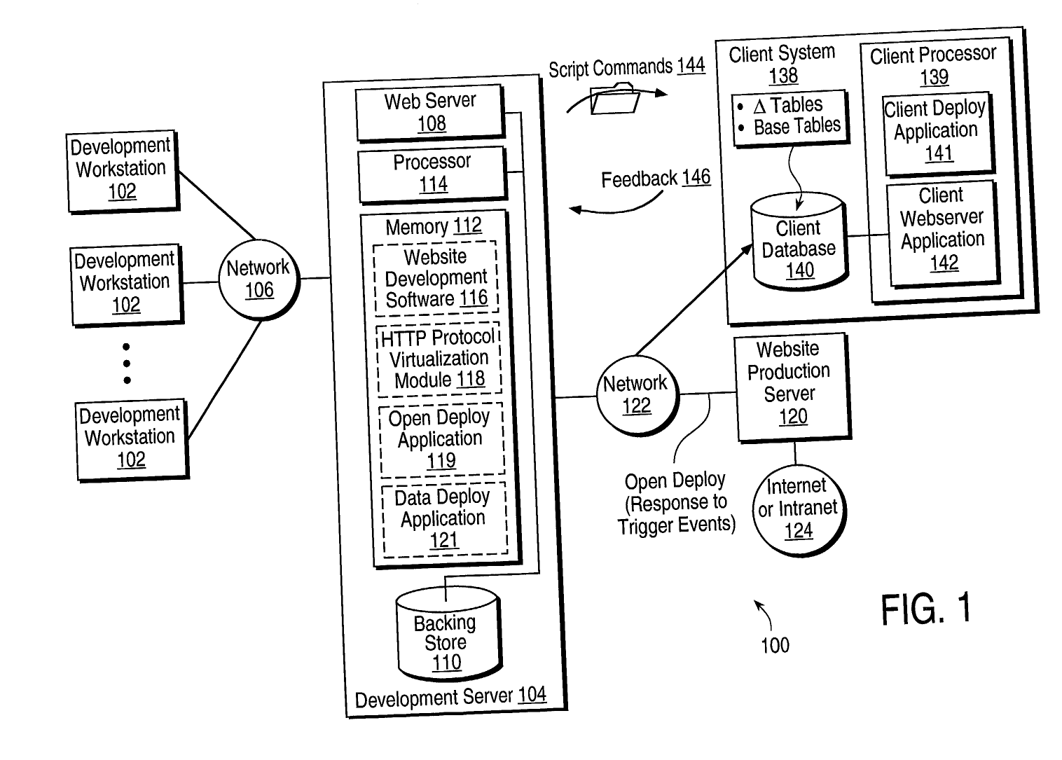

Referring to FIG. 1, a block diagram of such an application is shown incorporated in a system for website development and maintenance. The website is maintained by users occupying workstations 102. The users develop particular areas for use within the website in individual work areas, which are stored separately from other areas. Once a user working within a work area has completed a task for the website, the user may submit the content to a staging area for review. The staging area is configured to hold information pertaining to areas within the website from the multiple work areas. The proposed changes to the website can be displayed at the staging area for review before they are published in the final website. Once the changes are approved at the staging area, the changes may be published by deploying the web content and the website is modified. According to the invention, script commands 144 may be deployed along with content to cause scripts to be executed at locations along the deployment path to further control the deployment, including the web server that hosts the website. In a preferred embodiment, these scripts exist in entities along the deployment path prior to the deployment.

In order to perform the development of content according to this functionality, the proper deployment of different types of data must be achieved. The concept of deployment includes the transfer of different types of data in particular ways to particular locations, perhaps multiple locations. File data, such as web content, may be transferred to a target file system, such as a production server where the web content is displayed to web browsers. Metadata and template data, which relate to the web content or other file data, may be deployed to certain data bases where they are utilized.

In order to store particular information properly, a user utilizing conventional methods typically must compile the changes created in a work area into a file and store the file in the database. Taking into account the voluminous and varied information produced in a work area, this can be an arduous task, requiring considerable time to execute. Of course, this takes precious time away from the task of producing and maintaining a website. The development server may be configured to automatically store in-progress changes of web content developed. Once completed, the changes may be deployed according to the invention.

In another embodiment of the invention, a method and apparatus for the deployment of data is provided that includes the ability to execute certain software program scripts at various phases of the deployment of the data. Such an embodiment may be employed to monitor the deployment of the website content from the initial deployment of the data from where it is generated. This may be accomplished up to and including the website production server by broadcasting results of deployments, such as the beginning and end of a deployment, the success or failure of a deployment, and other information related to a deployment.

In operation, script commands may be deployed to destinations along the deployment path and directed to executable scripts stored in configuration files of devices existing along the deployment path, such as a production server. The scripts are configured to cause operations to be performed on these devices upon their execution. They may be executed upon a deployment, upon delivery to a certain destination, in response to a command sent from another device or entity, or upon the occurrence of certain events. Commands may be sent to these devices to cause the scripts to be executed by a processor communicating with the device, causing the operations configured within the scripts to be performed. For example, upon a successful deployment, a script may be executed to inform an interested or concerned party of the deployment that the content was delivered. An interested or concerned party may be a person, another machine, or some other entity to which the deployment pertains. Similarly, upon a failed deployment, a script may be executed to inform the interested party of the deployment, and possibly request a subsequent re-deployment by the source of the content, such as the development server 104. In another example, a script may be executed on a secondary development server to further deploy the content to one or more production servers. In general, deployments may occur between almost any device along the path of deployment, and in either direction. More examples are discussed below.

The invention allows for the deployment of website content and other data to website production servers while being controlled and monitored at entities throughout the deployment process. For example, scripts of programmable software may exist on devices and can be executed at various points of the deployment process. The particular deployment transactions as well as the executed scripts may be logged in a memory location that can be reviewed by entities throughout the process based on their authority to do so. In response to certain deployment events, operations may be executed by sending commands to execute the scripts. Such events may include the initiation of a deployment, the completion of a deployment, the failure of a deployment, and other operations related to the deployment of content and other information.

A large number of disparate systems communicate via the Internet exchanging disparate web content and other types of data and software programs. As a result, the environment is terribly heterogeneous. Such an environment may not be suitable for exchanging web content and other data among disparate devices and systems using conventional methods. Utilizing the invention, the deployment of content can be configured to adapt to many disparate devices. A device or system configured with the invention may also adapt itself to disparate computer systems operating on different platforms such as Solaris, AIX, Windows NT, and Windows NT Alpha and other systems. The invention allows the deployment of content among these various platforms to provide centralized, synchronous and secure communication among the different entities. As a result, more robust deployments can be accomplished among disparate computer systems, using disparate content, developed by disparate users for access by other disparate computer systems. Now, disparate devices connected to heterogeneous networks such as the Internet can finally communicate.

Utilizing the invention, in one embodiment, a central intranet can be accessed and updated by individuals from multiple locations, even if the locations are within separate firewalls or synchronized via unsecured Internet connections. Script commands may be attached to data such as web content and sent to various entities, such as web servers. This data may be verified and deployed according to a predetermined configuration. According to the invention, scripts may then be executed at either the source of the data, the destination of the data, such as a destination server, or at various phases of deployment. Commands may then be sent to execute the scripts. This would allow for external task execution during the deployment of the web content throughout the system.

For example, a user can run a script to automatically stop and restart a web server before deployment of the data starts. This allows an entity deploying the content to control a web server by simply sending the commands along with the content to execute the scripts. Then, the scripts can cause certain tasks to be performed. Scripts may also be attached to content and can be executed upon delivery, sending a notification to an entity on the system that verifies that the deployment has been completed and was successful. Using this reporting capability, scripts can also report failures in deployment so that data may be redeployed or otherwise analyzed.

In one embodiment, scripts may be deployed for running language-checking operations during deployment to notify the destination web server. Such a script, when executed, may inform a webserver that a particular format of data is included within the format being sent. The webserver can then adjust accordingly to accommodate the data if needed.

Scripts can also be attached to web content in order to send transactional and script execution information. In such an embodiment, scripts may be attached to data to convey status information to a central location. For example, the scripts, when executed at the destination, may cause the recording and logging of information related to the activities that occurred throughout deployment of the attached data.

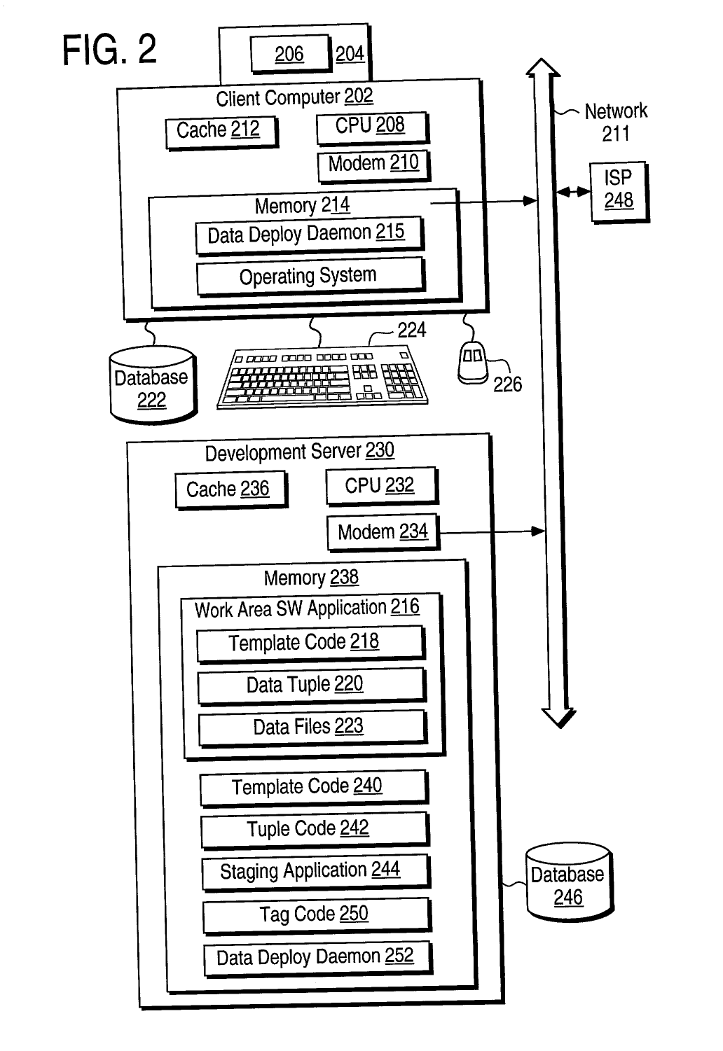

In order to understand one embodiment of the invention related to deploying scripts in website development and maintenance solutions, it is useful to understand an example of such a solution. FIGS. 1 and 2 illustrate such an example of such a system. Referring again to FIG. 1, in one or more development workstations 102, website developers may add, remove, edit and examine files for a website. Development workstations may include conventional personal computers, UNIX workstations, or other workstations that can be configured to develop content. The development workstations 102 may be connected to a development server 104 via a computer network 106, such as the Internet or LAN.

The development server 104 may include a web server 108 for serving up content to web browsers, and a backing storage 110 for storing versions of website content. The server 108 processes HTTP requests from the development stations 102 for website content (e.g., files). The website files may be physically stored in the backing store 110 which may be conventional, such as the WINDOWS NT filing system commercially available from Microsoft Corporation. The backing store may serve as a central location to store all data that is created, transferred, or otherwise maintained within the system. The storage of data may be executed transparent to the user.

The development server 104 may also include a conventional memory 112 (e.g., RAM) and a conventional processor 114, which implements the website development methods of the present invention by executing software code 116 stored in the memory 112. An HTTP protocol virtualization module 118 may be executed by the processor 114, allowing web server 108 to operate as if it were multiple servers. The module may also be stored in the memory 112.

Open deploy application 119 may be included in development server 104 to enable the government and monitoring of the deployment from the development server's point of view. Such an application may include scripts that may be executed on the development server. It may also include commands that may be sent to other devices or entities associated with the deployment of data to execute scripts. Custom systems may be written to generate other files or configuration files to be used by the production server.

Data deploy daemon application 121 is configured to enable the deployment of metadata and templates to client database 140. In this example, templates and metadata may be transferred to client systems as database content where delta tables and base tables are maintained. These templates and metadata may then be used by the client in maintaining its website.

The development server 104 may be coupled to a website production web server 120 via a network 122. Network 122 may be the same network as network 106 or a different network. The web server 120 may also be coupled to the Internet or an intranet 124. When a website is ready to be posted on the World Wide Web or on an intranet, the development server 104 sends the website content to the production web server 120 which then provides Internet or intranet access to the website, depending on the system configuration. Network 122 may deploy data to client database 140 that originated in development server 104.

Client system 138 may include database content that includes delta tables and base tables used in developing and maintaining websites. The client system may also include client processor 139 for controlling the inter-workings of the client system, such as receiving and deploying content and related information, including scripts and their respective commands that cause their execution. Client processor 139 may include client deploy application 141, that may be configured to interact with open deploy module 119, a deploy application located in the development server. Together, the deploy applications can enable the development sever and the client system to monitor and control the deployment process.

A base table may be established in client database 140. The base table may be a snapshot of a staging area located within development server 104. These base tables may be updated as the staging area changes via further data deployments. The database services client webserver application 142, which may make changes in order to maintain its own website or other application that the development server services. In this respect, delta tables may be established in database 140 to preserve changes that users may make in client application 142. In one respect, the delta tables and base tables operate along with the client application similar to the function of the development workstations 102 that send changes to staging areas. In this respect, the client application may act as the workstation. The changes in delta and base tables emulate the corresponding content in work areas and a staging area. The benefit to this configuration is that maintenance of a website may be under the control of the development server, or may be separately under the control of the client application in conjunction with the client database.

A website is generally comprised of the contents of an arbitrary file system. The website development system 100 of the present invention may include hierarchical file systems. Each such file system of the present invention provides an environment for managing and manipulating individual files. When executed, the website development software 116 enables the management and manipulation of files. The backing storage 110 is where the files and corresponding metadata may be physically stored. Metadata is generally data that is related to work content. Some examples include for example content owner identification, group identification, access control, file name, modification times, creation times, extended attributes (EAs), website addresses associated with the content, and other information related to the content.

A hierarchical file system of the present invention may be referred to in the art as an “area.” There may be different types of areas including work areas, staging areas and edition areas. A work area may be a modifiable file system that is used by persons who create and maintain web content in work files for eventual use in a website. A staging area may be an area where content from these work files is assembled before it is published. A central control person, such as a webmaster, may review content submitted from work areas within a staging area or an edition area. Since the work areas are generally areas for creating and maintaining content exclusively, the staging and edition areas may be restricted to only assembling and displaying content. By design then, they may be configured as read-only file systems. Any modifications to content may then possibly need to be sent from an editor back to a workstation to perform any changes that may be needed. This helps to maintain the integrity of the content and to simplify the process. However, a business may want the system 100 to be more flexible, allowing other people such as editors to modify the content before it is published. The automatic storage and possibly modification of data upon the occurrence of certain events may be desired in order to preserve data produced or otherwise modified during development or maintenance of a website. This way, different versions of content may be preserved and time-stamped, allowing developers and possible editors and administrators the ability to revert back to different versions of the content.

For example, content may be submitted to a staging area for review. Upon the occurrence of the submission of data, metadata associated with such content may be modified in order to distinguish the changes made from the original version. This way, different versions may be preserved and organized. To save space, only the deltas, or actual changes, may be stored from each version. This can be useful in the day-to-day operations of a website. For example, an airline may advertise different fares online, to which purchasers may order tickets for flights. An error in publishing a fare may occur, such as a fare that is much lower than planned, giving purchasers a windfall. A website administrator may then revert back to the earlier website, and avoid losing money by selling too many low fares. Having older versions of content, therefore, may be crucial to certain businesses.

In addition, the application may be configured to keep metadata and template data changes in delta tables, which emulate the corresponding content in a staging area. Tracking table (not shown) tracks the different changes proposed for the website as it is modified in response to changes proposed by each client work area and may be accepted by an authority of the client. The tracking table is configured to track the various tables created, such as base tables, and also tracks the interrelationship among the various tables. The tracking table may keep track of the characteristics of the different tables such as the times and dates in which they are created, the interrelationships of the tables such as which base tables correspond with different delta tables, and other characteristics. In such a configuration, data may be deployed from a development server to a webserver. One embodiment of the invention is directed to the ability to control and monitor the deployment of the data throughout the deployment process.

In such an embodiment, executable script commands 144, generated by a script generator (not shown), may be deployed along with content in order to control and monitor the deployment of data. For example, it may be desired to start and stop the webserver during deployment, so that data and possibly software code may be loaded onto the server. A script configured to perform the operation could exist on the webserver. A command 144 may be deployed along with the data deployment to cause the script to be executed. Upon execution of the script, the webserver could be stopped in order for the content and other information to be loaded, and then could be started again once the new content is ready to be produced on a website. Using these scripts, feedback signals 146 may be sent to the development server 104 to inform the server of conditions surrounding the deployment. For example, feedback can include information related to the success or failure of a deployment, the beginning or end of a deployment of data such as content or directories, and other information related to the deployment of data. These may be in the form of an email message or other transmission, an update to a log file, or other form of communication.

Referring to FIG. 2, a block diagram of a system employing a deployment application in accordance with the invention is illustrated. Such a deployment application is discussed in connection with a website development and maintenance solution as discussed above. The system includes a client computer 202 connected to a monitor 204, which has a display 206 for displaying data to a user. The computer may be configured to maintain websites served from a client location. The client computer 202 includes a CPU 208 for controlling the inter-workings of the computer and a modem 210 connected to a network 211 for sending information to other destinations. The client computer 202 further includes cache 212 for storing frequently used data. Memory 214, controlled by CPU 208, can be a conventional memory and can be a random access memory (RAM), a dynamic random access memory (DRAM), a static random access memory (SRAM), or any other memory configured to store and transfer digital data therefrom. The memory 214 may include one or more work areas that may be defined as a collection of directories located on the development server, thus, not a separate computer in and of itself. Thus a work area may be defined merely as a set of files that a user at a client or development computer has authority to access.

If on a separate computer, it will be apparent that the computer 202 is conventional and that various modifications may be made to it. Also communicating with work area computer 202 is an optional database 222 for storing data that is easily accessed by a user. Data can optionally be stored in data files 223, which gives a user an organized way to store data. Memory 214 may also include a conventional operating system, such as Windows, for receiving content from the development server to further develop and maintain. Computer 202 also includes a keyboard 224 and mouse 226 that allow a user to input data.

The system of FIG. 2 further includes a development server 230 having a CPU 232 for controlling the inter-workings of the server 230 and a modem 234 connected to network 212 for transferring data using the network. The development server 230 includes memory 238 that includes work area software application 216 that includes template codes for creating and storing templates used for displaying data. These templates define the displays used on the website, so that a user having a graphic user interface (GUI) can read the data displayed in the selected template format. Also stored in the memory 214 is data tuple code 220 for storing and transferring data in the tuple format. The server 230 further includes a cache memory 236 for storing frequently used data and a conventional memory 238. This cache 236 may reside in software in the memory 238 as well. Thus, it will be apparent that the server 230 is a conventional server and that various modifications may be made to it. Memory 238 may include template code 240 for storing and creating templates to be used on a website. The server 230 may further include tuple code 242 for storing and transferring data in a tuple format. Tuple code may be a software application configured to deploy data. Further included is a staging application 244 for staging contributions to the website by multiple work areas. The staging application 244 can configure the template code and tuple code for displaying data on a website in a given template format. Also included is an optional database 246 for storing data to be accessed by the development server 230. ISP 248 may also be included in the system of FIG. 2 to allow the work area computer 202 and development server 230 to exchange data via the Internet, another example of network 211. Data deploy daemon 252 is also located in memory 238, and may be a software application that is configured to deploy data based on certain trigger events. Tag code 250 may be included for associating tags with deployed data, files, or other information. Data deploy daemon 252 may correspond with data deploy daemon 215 located in the development server. Together, these daemons may allow the monitoring and control of data deployments between the development server and the client system.

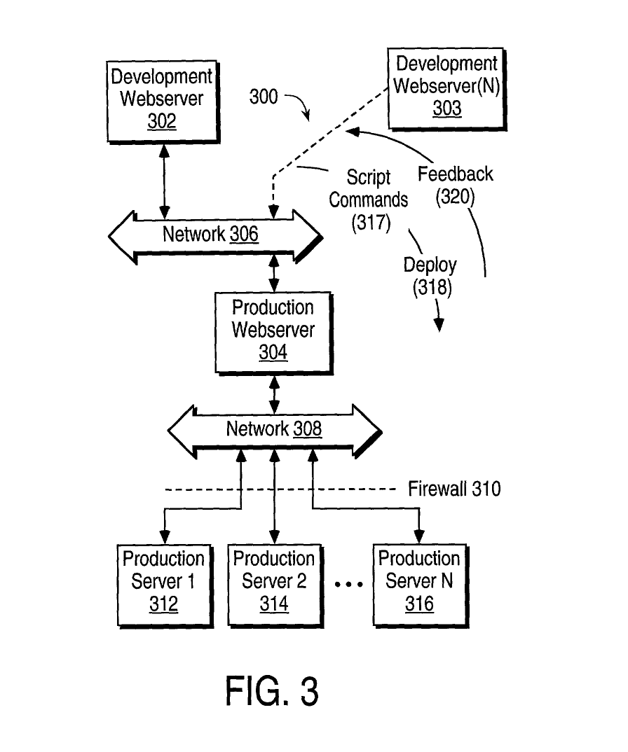

Referring to FIG. 3, a network computer system 300 is illustrated wherein one embodiment of the invention is utilized. A development web server 302 communicates with a production web server 304 via network 306 in order to transfer content from the development web server 302 to production web server 304 with possible integration with other website content. The network 306 may be any number of networks such as a local area network (LAN), the Internet, or other types of networks used to facilitate communication among multiple computers. The production web server 304 may be connected to a second network 308 which could also be a LAN or could also be the Internet. The production web server 304 may communicate with production servers 312-316 which communicate with network 308. Such a configuration may be characterized in the art as a “production farm”, where a number of webservers, proxy servers, and other website host devices proliferate the web content via multiple sources.

The production servers 312-316 may be subject to a firewall 310, which governs the transmission of data between the network 308 and the production servers 312-316. According to the invention, the transmission of content from the development web server 302 to the ultimate web production servers 312-316 may be monitored and documented so that transactions and executed scripts can be analyzed. When sending data in a deploy direction 318, scripts can be executed throughout the entire data path in order to accomplish certain goals. Feedback information can be deployed in the feedback direction 320 so that an entity within the data path can analyze the entire deployment process as it occurs.

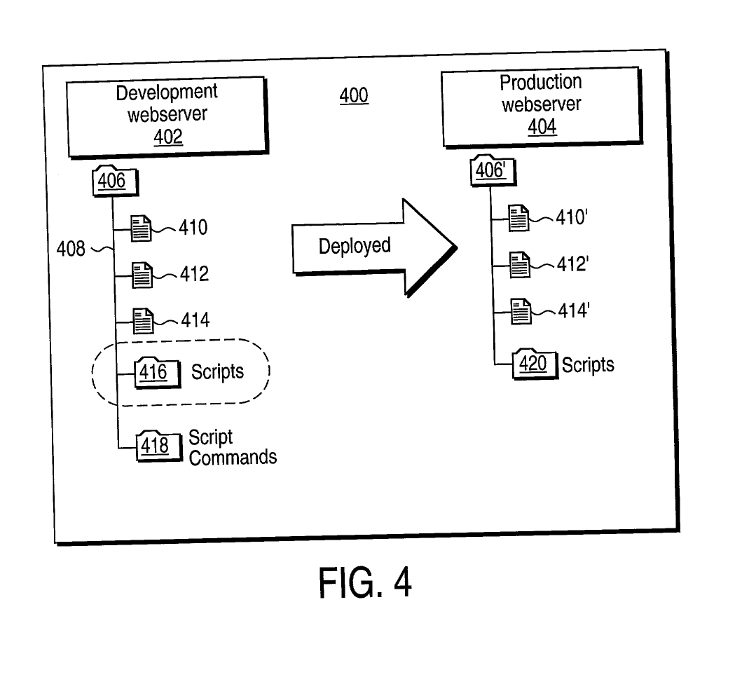

Referring to FIG. 4, a functional block diagram is shown to illustrate the use of scripts. The development webserver 402 is configured to deploy data to production webserver 404. The deploy file 406 may include content 410, 412, 414, executable scripts 416 and script execution commands 418. Optionally, the scripts may be sent to the production webserver by the development webserver. In a preferred embodiment, the scripts pre-exist in the production webserver prior to deployment.

Commands 418 may be deployed along with content in order to effectuate the execution of the scripts. Scripts may reside on the destination server, such as the production server. Commands 418 may be transmitted either alone or along with content and related information to cause the scripts to be executed and to perform tasks on the production server.

In a preferred embodiment, the scripts reside in a configuration file on the server where they are executed. In one embodiment, scripts may be configured on either or both the development webserver 402 and the production webserver 404. In such a configuration, script execution commands may be sent from the development webserver 402 to the production webserver 404, and vice versa. This allows for command interaction between the two servers, making the deployment more robust. In one embodiment, script commands are sent in response to trigger events such as the beginning and end of a deployment, the success or failure of a deployment, etc.

Scripts that are run on the production webserver may govern operations such as stopping and restarting a webserver before, during or after a deployment. In common deployment scenarios, a webserver must be stopped, have new content loaded in, then restarted so that is can product the new version of the website with the new content. With scripts located at the production server, commands may be sent from the development server to start and stop the server accordingly.

Scripts may also be run to install software components on the production webserver. Such components may be software modules configured to enable the deployment of content, metadata and other information to a production server. For example, software applications or modules may exist on the development server that may be useful in aiding deployment. One example of a script would cause the components to be installed in the production server.

In another embodiment, the ability for either the production server or the development server to send emails upon the execution of a script is provided. For example, upon a failed deployment, both the source and destination of the deployment are aware of the failure. Upon such a failure, according to the invention, a message may be sent by common email or other means to inform other devices of the deployment failure, such as other interested or concerned entities. These scripts for sending emails may reside on any and every entity along the deployment path, such as in a configuration file of a device. This feature of the invention gives the development server the ability to broadcast the status or result of the deployment of web content to interested or concerned entities.

Scripts may also be configured allow and entity in a system to send a command to retry deployment at the development server. Upon the failure of a deployment, or possibly upon other loss of data needed at a production server, a command may be sent to the development server to deploy the content and related information again. This embodiment allows for control of the deployment to switch to the production server to enable a repeated deployment. In one embodiment, the ability to deploy again may be limited to authorized entities within a system, such as designated production servers that are authorized to receive the content and related information. In another related embodiment, the deployment may be configured to automatically retry a deployment upon a failure.

In another embodiment of the invention, an entity may be configured to deploy content and related information to a number of destination devices. Such a configuration may be characterized as an administrative deployment from a production server to what is known as a web farm. Such a production server may be configured as a secondary deployment server that administers the deployment to these multiple production servers. This embodiment allows for scripts to reside on the secondary deployment server for execution upon a commands sent to them. Such a command may be configured to trigger a deployment to one or more selected production servers communicating with the secondary development server. Utilizing this embodiment, the deployment of content to particular production servers may be controlled by the development server. For example, certain types of content may be suitable in different geographical locations and in different cultures. Content may need to be translated, or otherwise modified before sending it to the final destination production server. Utilizing the invention, the delivery of the content can be controlled by sending out commands along with content to cause properly configured scripts to control the delivery of the content.

In another embodiment, certain scripts may be executed upon predetermined conditions. Such conditions may include the execution of a script before, during or after deployment. Other conditions may include the execution of a script before or after a file is deployed, or before or after a directory is deployed. Utilizing this embodiment, the execution of scripts may be limited to when they are executed. The scripts also may be automatically executed upon the occurrence of a predetermined condition, such as a failed deployment as discussed above. Upon a successful deployment, for example, the destination device, such as a production server, may be activated. As another example, upon a successful deployment, the subsequent installation of certain software components may be executed.

In a preferred embodiment, the scripts 420 may exist in the destination server prior to deployment. Therefore, they would not need to be deployed along with the content and other information. In the example of FIG. 4, this would allow the owner of the production webserver, which may be different than the owner or controller of the development server to create its own scripts that are compatible or otherwise customized for its system. In such a configuration, only the script execution commands 418 may be deployed along with the content. In another embodiment, updates or replacement scripts may be sent to the production webserver. In one embodiment, the command is in a deployment configuration file that is fed into the open deploy application 119. The command is a message that is sent over the network to the application 119 on the production server that instructs the application 119 to run the specified script.

At the receiving end, the deploy file 406′ is received and parsed by the production server 404, and the content 410′, 412′, 414′ may be placed in production or otherwise utilized. The scripts may cause functions to be performed at the production webserver. As discussed above, these scripts may include a trigger element, where they are executed or cause functions to be performed before, after or during deployment. The corresponding scripts 420 are executed, and the underlying functions are to be performed, as discussed above. This scenario may be reversed for deployments that include commands sent from a production or other device back to the development server.

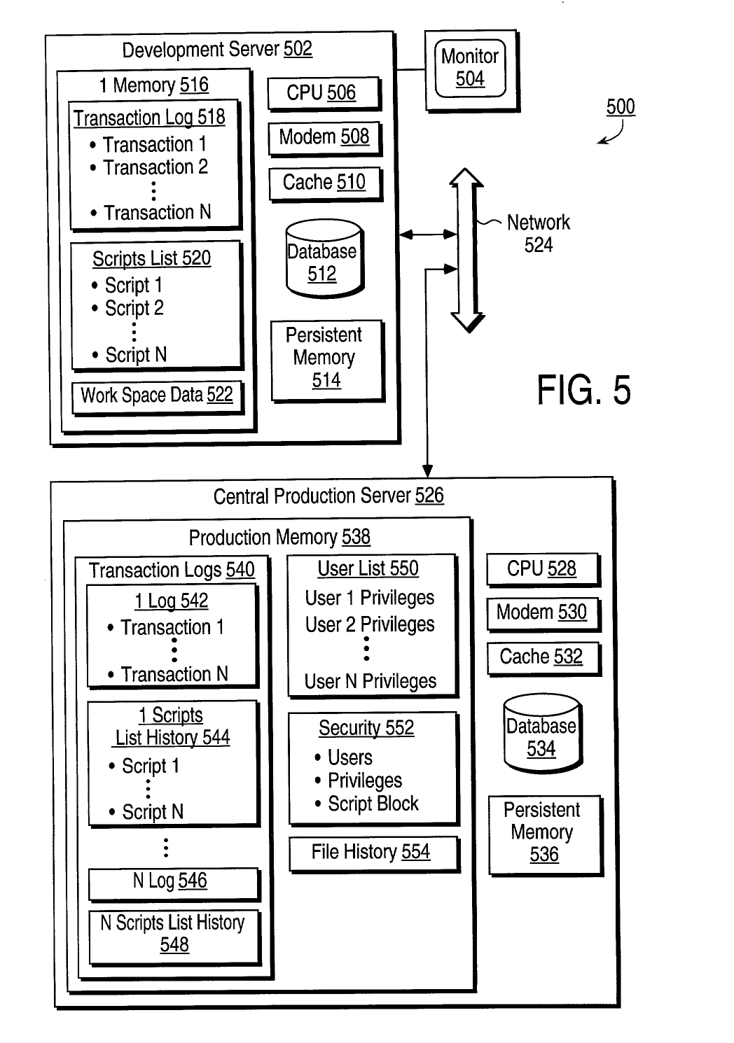

Referring to FIG. 5, a computer network system 500 similar to that described in FIG. 3 is illustrated. In another embodiment, the system includes a development server 502 having an optional monitor for use by a user operator. The development server includes a CPU 506 configured to execute software programs and manipulate and transfer data within the server. The server 502 further includes a modem 508 for communicating with other computers and entities external to the server 502 by transferring and receiving data therewith. Cache memory 510 is also included in the server for storing frequently used information executable by the CPU. Database 512 is configured to store large amounts of data for access and use by the CPU. Persistent memory 514 is also included to store prototypes of code and other information used by the CPU. Memory 516 may be a random access memory for storing information related to the creation and deployment of content by the server. Memory 516 may be any type of readable and writable memory device including random access memory (RAM), dynamic random access memory (DRAM), flash memory, and any other type of memory that is readable and writable.

In one embodiment, memory 516 includes a transaction log 518 for recording the transactions involved with the deployment of data for use on a web server. The transaction log is a useful feature that allows the recording of transactions involved in the deployment of data for review by a user or other entity. The transactions may be particular to the client owning or operating of the server 502 so that the transactions executed or otherwise involving the server 502 may be monitored. Memory 516 may also include script list 520 for storing scripts that may be stored within the configuration file of the web content data, for execution within the deployment process. The script list 520 may be a log of certain scripts that were deployed and executed by the server 502 and may also include further information including the viability of the scripts, the possible successes or failure of the scripts in prior executions, and other information related to the scripts. The scripts list may also contain the actual scripts including software code that may be executed during the deployment process.

As discussed above, these scripts can be useful in controlling and monitoring the deployment of data throughout the process. These scripts can be included in the configuration file to control and monitor the deployment of the particular contents. For example, the script can include software code that designates certain deployment targets where the content is deployed. A system may have multiple web production servers, the types of servers that allow access to websites stored on the servers by users connected to the Internet, the scripts within the configuration file can determine to which server the content will be deployed. Also, if multiple files are being transferred within the content, a script can be included in the configuration file to deploy certain files to certain locations as predetermined by development server 502. Upon deployment, a command may be generated to execute a script. Unlike the prior art, utilizing the invention, a user can perform a much more intricate and robust deployment of data that can be closely controlled and monitored.

Scripts can also be included to control the deployment of data of certain size files as well as certain times on which the data may be deployed. These are very useful functions that can greatly simplify the deployment of data over a period of time for files of various sizes. For example, if a website is to be updated on a daily basis, the scripts can be configured so as to deploy particular data on particular dates and times. Also, with large size files, portions of these files may be deployed in subfiles or in other configurations to allow the bypass of a firewall that may limit the amount of data that can pass into a particular computer system, network or other entity.

Scripts can also be included within the configuration file to deploy only portions of web content to a web server. For example, if less than the entire web content on a web page has been modified, a comparison can be done between the new content and the old content. The difference between the data can be determined. This difference, consisting of the newly added or modified data can be transferred, rather than the entire content. This reduces the amount of data being transferred to the production server.

Scripts can also be configured to designate files to be excluded or ignored by certain entities. These files could be overwritten, encrypted or otherwise blocked out from particular entities as predetermined by a user. Files can also be renamed, deleted or otherwise modified during the deployment based on the scripts within a configuration file.

Included within the scripts can also be certain authority or permissions that allow certain users, servers or other entities access to certain data, whether it be the monitoring of data or the actual control of the deployment of the data. The scripts can be configured to also modify the permissions during the deployment by certain authorized entities. This can greatly add to the flexibility of the deployment process, allowing for proper authority to be delegated so that the web content can be properly deployed in a multitude of situations.

In order to deploy web content over disparate computer systems, web content is often deployed in various formats and under various conditions in order to adapt to particular users, particular content and particular systems that utilize the content for serving web pages. Utilizing the scripts features, web content may be deployed under various formats by initializing and loading data into particular computer systems or entities according to the scripts. These scripts may correspond to particular computer systems or formats that are utilized in computer systems that utilize the web content. Scripts may include certain special treatment links that may be affiliated with certain computer systems. The scripts may be configured to follow the links that are designated by the computer systems, or to ignore the links and perform its own procedures for downloading or otherwise deploying the data into particular computer systems. These scripts can also include particular ports and Internet protocol (IP) addresses to which data may be deployed. These various addresses or ports may be configured within the scripts for controlling and monitoring the deployment of the data within a particular system.

Scripts may be configured to spawn particular functions at different points along the deployment path. The preceding discussion is an embodiment of the invention where the development server is configured to deploy and run the scripts throughout the deployment process. It is also possible to enable other entities throughout the deployment process to govern the control and monitoring of the deployment process, including attaching scripts to web content as well as executing certain scripts at various points of the deployment process.

Still referring to FIG. 5, production server 526 is included and configured to communicate with development server 502 via network 524. The network may be a LAN, the Internet or other type of computer network. The production server 526 may have the ability to execute certain scripts according to commands sent by the development server 502, and may also have the ability to execute certain of its own stored scripts or other protocols that may aid in the proper deployment of web content. Referring again to FIG. 3, this production server 526 similar to the production web server 304 FIG. 3, could be useful in the deployment of web content between multiple development web servers 302, 303 and multiple production servers 312-316. In such a configuration, a central web server such as the production web server 526 may be useful in transferring data among these entities, which may be disparate computer systems and may also be transferring disparate web contents according to a number of rules as defined by the scripts located in the configuration files. The production server 526 may include internal scripts that allow it to perform as a go-between among the various entities in the system.

The production server may include a CPU 528 for controlling the inner workings of the production server as well as transferring and manipulating data both internally and externally to the production server. The production server further includes a modem 530 for communicating with entities connected to the network 524 and for transmitting data among these entities under the control of CPU 528. The production server further includes a cache memory 532 for storing data that is frequently used by the CPU. Database 534 is also included for storing large amounts of data that can be accessed using useful protocols according to the database. Persistent memory 536 provides a location for storage of information in possibly a nonvolatile configuration, which can be accessed by the CPU.

The production server further includes production memory 538 for storing software content such as website content, software programs that are executable by the CPU 528, and other data that is useful in the production and deployment of web content throughout system 500. Included within the memory are transaction logs 540 that are configured to store and maintain transactional and script data that pertains to any particular development server, such as development server 502. Log 542 includes the various transactions that occur between the production server 526 and the development server 502 that pertains to the deployment of data between the development server and the production server as well as throughout the network 524 and other entities communicating therewith. For example, when a file having web content is transferred from the development server 502 to the production server 526, a transaction is recorded in the log 542 that contains the transactional information. This information may include the time and date the content was sent, any scripts that may have been executed according to commands and any results of such execution, the location to which it was sent, the type of data that was within the content, and other information pertaining to the deployment of such data. This transactional information pertain to log 1 may be accessible by the development server 502, and possibly other authorized users that can access the production server 526 to view the transactional history of the development server 502. The transactional logs 540 further include scripts list history 544, which may include certain scripts that were transferred and possibly executed under the direction of the development server during a deployment of data.

In another novel aspect, certain privileges may be established in order to provide a level of security to deployments and related operations. These privileges may include the authorization of certain individuals, entities or identified devices to deploy data and perform certain functions related to deployment. The privileges are preferably predetermined so that the production server may screen incoming deployments accordingly. Screening may occur by receiving identity data from the source of the deployment, which may be the original source, or another source along the deployment path. These privileges may apply to either or both sides of a deployment. However, in a preferred embodiment, the primary use for privileges is to control access to the production server by entities seeking to deploy date thereto. Authorized users may be identified in a authorization file within the production server, such as user list 550.

Script lists may also include certain privileges that may pertain to particular scripts. These privileges may include a list of privileges for other users to access and use these scripts, or may also include the limited authority under which the development server 502 may deploy and order the execution of these scripts.

The transactional logs may include the transactional histories of various entities including N log 546 and N scripts lists history 548. These separate logs and scripts lists histories may be stored in separate locations within the production memory 538 for individual access by certain authorized users. Production memory 538 may also include a user list 550. This user list may include user addresses, other user identification information, privileges under which certain users may perform certain deployment of data and other privileges that may give particular users access to certain logs or scripts lists for monitoring the deployment of certain data. This user list and the associated privileges may be predefined by development servers that are operated by particular users, or may be defined to the particular production server 526 that may be the primary authority for the transmission of certain web content throughout the system 500. As discussed above, this may be important in a system such as that described in FIG. 3, where many computer entities, possibly disparate entities, transmit data among themselves.

In another novel aspect, production memory 538 may also include security module 552 including code that may define the privileges that are associated with particular users. The security module may be configured to screen incoming data deployments. Such deployments may originate from remote devices sending data such as web content for display in the production server. The security code 552 may be invoked upon the initialization of a user with the central production server 526 when trying to gain access to particular transactional logs or when trying to deploy data. The security code may also include a script lock that may disallow the execution of particular scripts under the authority of the central production server 526. This function would be useful, again in reference to FIG. 3, if the production web server 304, acting as a central production server such as 526 (FIG. 5), is acting as the central and primary authority for the transfer of web content within the systems 300, 500. Production memory 538 may also include file history 554, configured to track the history of the different files that may be transferred or otherwise deployed within the system 500.

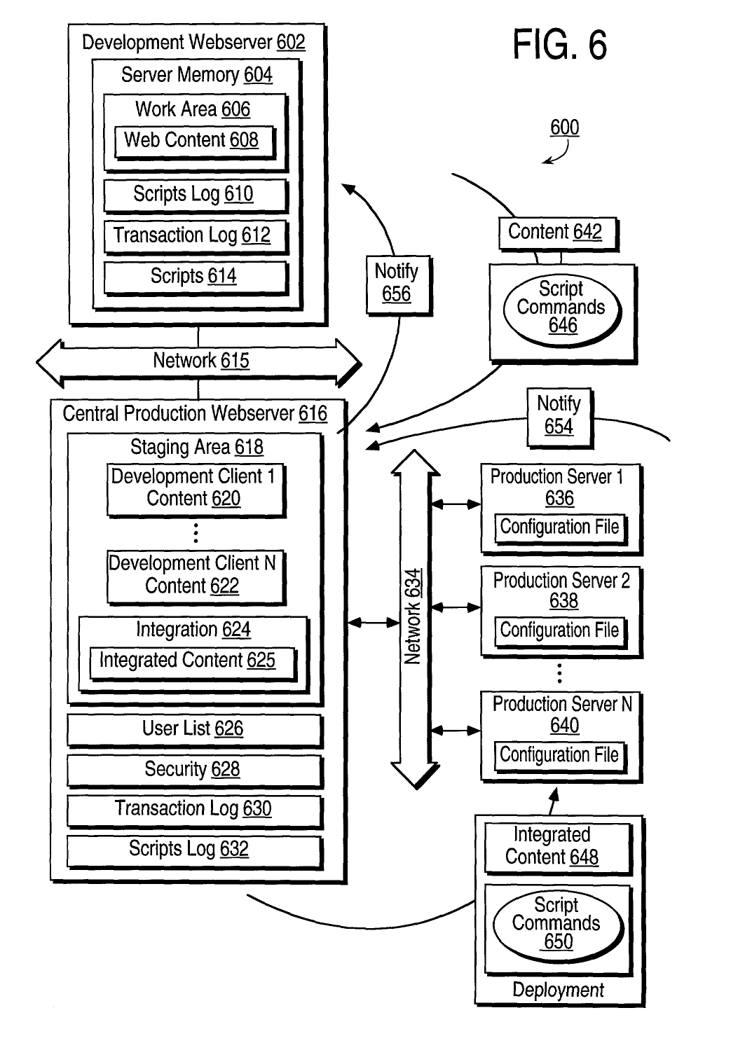

Referring to FIG. 6, a block diagram is shown for illustrating a possible function of a computer network system 600 that utilizes one embodiment of the invention. The system 600 may include development web server 602 having server memory 604 for storing software applications and content that may be produced by certain applications for eventual deployment to a production web server. The server may include a work area 606 that includes software application code for creating web content 608 for eventual deployment. The development web server may also include a scripts log 610 and a transaction log 612 for storing and tracking certain scripts and transactional information that may have been utilized by the development web server in deploying data. The log may be an XML based content transfer log, configured to retain a complete record of any content transfer within a system. Such a log may contain information regarding script execution or failure, error records from failed deployments, and other information related to deployment. Server memory may also include scripts 614 that may be incorporated into configuration files of deployed web content for execution during the deployment of data. These scripts may ultimately reside in configuration files located in the memory of the development webserver, the production server or servers, or other locations along the deployment path where the execution of such scripts may enhance the deployment process. For example, the log may have error entries in it, which may be parsed out by the server. In response, a script may be executed to somehow deal with the condition, such as halting the deployment of data.

The development web master 602 communicates with network 615, which also communicates with central production web server 616 to enable the transmission of data between the two servers. Central production web server 616 includes a staging area 618 configured to integrate and combine content received from possibly multiple development web servers and producing a final web page that includes the integration of the entire content. This is very useful for systems that allow multiple users from different development web servers to work on one web page that is displayed at a production server. The staging area 618 may include content 620, 622 received from various development entities, or different development web servers, that may be integrated into a final web page. The integrated content 625 may be stored by the integration application code 624, which may include application software for integrating various content received from different development web servers.

A central production web server 616 may also include the user list 626, security code 628, transactional logs 630 and scripts logs 632 such as those described above in connection with the central production server 526. The central production web server communicates with network 634, which may be a LAN, the Internet, or other type of network system. The network 634 may be connected to several production servers 636, 640 that are configured to store and allow access to web content deployed among possibly various development web servers, a central production web server and other production servers.

Still referring to FIG. 6, in operation, the system may be configured to deploy data between the development web server 602 and the production web server 616, and also between production web server 616 and production servers 636-640. A user communicating with the development web server 602 may create using work area 606 web content 608 for transmissions within the system 600. The development web server bundles the content 642 with script commands 646 that may be sent to scripts stored in a configuration file to spawn certain operations in the deployment process.

In a preferred embodiment, commands cause pre-existing scripts to be executed, possibly upon certain conditions. The contents 642 along with the script commands 646 may be transferred to the production web server 616 via network 615 for processing. The configuration files associated with the production server 636-640 may include scripts that define the initialization and downloading of the information into the production web server. This may include the integration of the content with other content that may be destined for the same website production server that hosts the website onto which the content is displayed. If the content is to be integrated with other content, it is integrated in the staging area 618 using integration code 624 to create the final integrated content 625. In either event, either the original content 642 or the integrated content 625 is transferred to one or more of the production servers 636-640 for publication onto a website. Commands may be sent from a development server to the central production server to cause the deployment of content to production servers by causing scripts located on the central production webserver to be executed.

Publication onto a website may involve the shutting down of a production server so that the new content can be loaded into memory within the production server. In operation of the production server, computer users having access to network 634 may access the server in order to visit the website, i.e., read the website file located in memory in the production server. The scripts that exist in the production server may define the initialization of the production server, including authorization information that allows the content to be deployed onto the particular server. The script commands 650 or 646 cause such scripts to be executed to perform operations related to deployments of data content, and may also include other features that relate to the deployment of the data. For example, once the content or integrated content is deployed onto a production server, a notify message 654 indicating that the deployment was successful. This notification could be sent production web server 616. The central production web server 616 may store the notification information into the particular transaction log 630 in order to log the successful or unsuccessful deployment of the content. The scripts log 632 may also be updated with this information to indicate that the script that was successfully executed. This notification message 654 may be sent by a triggering event, such as a successful or unsuccessful deployment of data, as defined in the scripts within the configuration file. This notification may also be sent by configuration code located within the production server. Another notify message 656 may also be sent from the central production web server 616 to the development web server 602 in order to update the scripts log 610 and the transaction log 612. The scripts code 614 may also be updated.

The sending of a notification message is an example of an operation that is spawned from the scripts that are transferred along with content, or that may reside in either the central production web server or a production server. This particular operation is indicative of an operation that allows the monitoring of the data deployment throughout the system. The notify message updates the various servers to inform as to the success or failure of the data deployment. Other scripts can be included in the configuration file in order to spawn different operations throughout the deployment process in order to enable advanced deployment operations. One example of a more advanced operation is the integration of web content within the central production web server. As discussed above, the scripts may be located in different locations and possibly within different entities throughout the deployment process. The central production web server 616, for example, may have script commands that override and supersede script commands that are sent along with the content from development web servers, for example, in order to ensure the uniform processing of content and other data throughout the deployment process.

The invention provides the ability to enable content production and replication throughout the deployment process. For example, if data was to be deployed to various disparate production servers 636-640, operations can be performed on the content in order to conform to the different production servers so that deployment can be accomplished. Also, if for some reason deployment failed on any one production server, the invention allows for notification back to either the central production web server or the development web server so that the content can be resent to the production server where the deployment failed in hopes for a subsequent successful deployment. The features included in a system embodying the invention allow for a user or other entity to know what data was transferred, what deployment of data succeeded, what deployment failed, and also allows access to the content or the transactions and scripts associated with the content by authorized users for tracking the deployment of the content. Also, operations may be performed on the content that is related to the type of content that is sent. This can be defined by the scripts included in the configuration file. These operations can be spawned or can be originated from either end of the deployment transaction, whether it is the server that is sending the data or the server that is receiving the data.

The monitoring aspect of the invention allows for the possible maintenance of state tables based on which deployments occurred and what operations were executed during any particular deployment. These activities could be as simple as starting and stopping a production server in order to load web content. They can be as complex and robust as the deployment of multiple batches of content, and be included along with individual scripts that may conform to multiple and disparate computer systems hosting the content.

Another application may be the deployment of updated software applications to multiple servers that host content. For example, a deployment of content may be executed that includes scripts within the configuration file that updates a multitude of production servers. Although the content may be delivered to less than all of the production servers, it is possible to update the software application code in one or more of the servers. The scripts may be particularly configured in order to spawn the operations that are required to enable particular deployments.

Unlike the prior art, the invention allows the deployment process to be completely transparent to authorized users. The invention also allows for robust control during the deployment process so that certain deployment operations can be modified in order to accomplish certain goals. In conventional goals, the deployment process acted as a type of “black box,” the operations of which were completely predetermined according to a particular system. This is impractical for modern-day Internet operations, which operate with disparate content, between disparate users that may be operating with disparate computer systems. The invention allows for the flexibility to work with these different systems, adapting the deployment operations to particular systems according to scripts that may be located within the configuration file of the content being transferred, or that may be configured within a server along the deployment path having the authority to spawn certain operations according to particular content deployments.

In general, the invention may include the utilization of dedicated processors, webservers configured to receive and route browser requests, application servers, state servers and other types of computer processors configured to communicate amongst each other and that may be connected to one or more networks, including a Local Area Network (LAN), an intranet and the Internet. However, it will be appreciated by those skilled in the art, such implementation of such devices and systems are but few illustrations of the utility of the invention, and that the invention may have greater applicability and utility in many other applications where efficient routing and processing of data within one or more networks is involved. Equivalent structures embodying the invention could be configured for such applications without diverting from the spirit and scope of the invention. Although this embodiment is described and illustrated in the context of devices and systems for exchanging data among users of a computer system or network, the invention extends to other applications where similar features are useful. The invention may include personal computers, application servers, state servers or Internet webservers that are designed and implemented on a computer and may be connected to a network for communication with other computers to practice the invention. A system configured to operate according to the invention may include a plurality of personal computers connected to the Internet via individual modems or other communication means such as wireless communications.

The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention, which is defined by the appended claims.

Within the different types of computers, such as computer servers, that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, or any commonly used protocol for storing and retrieving information to and from these memory devices respectively.

The apparatus and method include a method and apparatus for deploying data within and synchronously with the operation of a software application, and for executing executable scripts during the deployment process. Although this embodiment is described and illustrated in the context of a software application for developing Internet websites, the scope of the invention extends to other applications where preservation of data at either a data source or destination is useful. Furthermore, while the foregoing description has been with reference to particular embodiments of the invention, it will be appreciated that these are only illustrative of the invention and that changes may be made to those embodiments without departing from the principles of the invention, the scope of which will be defined in the appended claims.

What is claimed is:

1. A system for deploying data along with associated script execution commands in a computer network comprising:
a deploy module configured to deploy data to a destination via a deployment path; and
a script command generator configured to generate a script command upon a predetermined event to be associated with data to be deployed to a destination, the script command being configured to cause a script located at a location along the deployment path to be executed, wherein an execution of the script causes an operation to be performed by a device located at a location that is related to the deployment of the data.

2. A system according to claim 1, wherein the deploy module is configured to deploy web content for display to a production server, and wherein the script command generator is configured to generate a command to cause the production server to shut down so that the web content may be loaded upon deployment of the web content to the production server.

3. A system for deploying data in a computer network comprising:
a deploy module configured to deploy data to a destination; and
a production server configured to receive data deployed from the deploy module, and having a security module configured to screen incoming data deployments based on predetermined privileges established in the production server.

4. A system according to claim 3, wherein the production server is configured to receive identity data from the deploy module in order to identify the source of the data deployment.

5. A system for deploying data in a computer network comprising:
a deploy module configured to deploy data to a destination;
a script command generator configured to generate a script command upon a predetermined event to be associated with data to be deployed to a destination, the script command being configured to cause a script located at a location along the deployment path to be executed, wherein an execution of the script causes an operation to be performed by a device located at a location that is related to the deployment of the data; and
a log generator configured to generate historical data related to data deployments.

6. A system according to claim 5, wherein the log generator is configured to generate historical data related to executed scripts.

7. A system according to claim 5, wherein the log generator is configured to generate historical data related one of the following conditions related to date deployment: beginning of deployment, end of deployment, successful deployment and failed deployment.
